(19) United States
(12) Patent Application Publication
(10) Pub. No.: US 2024/0375626 A1
(43) Pub. Date: Nov. 14, 2024

(54) BRAKE MODULE

(71) Applicant: KNORR-BREMSE SYSTEME FUER NUTZFAHRZEUGE GMBH, Muenchen (DE)

(72) Inventors: Stefan Niedermeier, Haarbach (DE); Niklas Ulrich, Stockholm (SE); Martin Krahl, Ludwigsburg (DE); Stefan Wetterer, Muenchen (DE)

(21) Appl. No.: 18/654,358

(22) Filed: May 3, 2024

(30) Foreign Application Priority Data
May 12, 2023 (DE) 10 2023 204 486.2

(51) Int. Cl. B60T 13/68

(52) U.S. Cl. CPC B60T 13/683; B60T 2270/10

(57) ABSTRACT

A brake control module includes: a first brake-control-valve (BCV), the output of which is connected to at least one controlled port; a second BCV, the output of which is connected to a third controlled port; a third BCV, the output of which is connected to a fourth controlled port; a processor unit, which is adapted to control and/or influence brake pressures; at least one control port, which is adapted to activate at least one of the BCVs; in which the first BCV is connected to a first compressed air supply port, and the second BCV and the third BCV are connected to a second compressed air supply port. The brake control module allows the front and rear axle brake cylinders to be activated. Only one processor unit is required, which is in the central brake control module, and much of the wiring is eliminated.

### RELATED APPLICATION INFORMATION

The present application claims priority to and the benefit of German Patent Application No. DE 10 2023 204 486.2, which was filed in Germany on May 12, 2023, the disclosure which is incorporated herein by reference.

### FIELD OF THE INVENTION

The present application concerns a brake module, in particular for the implementation of an electronic braking system for commercial vehicles.

### BACKGROUND INFORMATION

Electronic braking systems are today becoming increasingly important. They generally involve electronic braking demands; in particular, a stability program may thus be used to ensure appropriate braking stability.

German patent document DE 10 2009 009 811 A1 discusses an electropneumatic pressure control module with pressure control channels having pneumatically separate circuits.

This is suitable in particular for electropneumatic braking systems of vehicles with at least two separately controllable pressure control channels, wherein, depending on braking demand signals from a braking-value sensor, a controlled working pressure present at at least one working pressure port for at least one brake application device of the braking system is generated for each pressure control channel on the basis of working air originating from at least one compressed air supply. Here, at least one dedicated supply pressure port, which can be connected to a dedicated compressed air supply, is assigned in each pressure control channel, wherein at least, starting from the respective supply pressure port up to the respective working pressure port, the pneumatic flow paths of each pressure control channel are formed pneumatically separate from the pneumatic flow paths of a respectively other pressure control channel.

In the usual braking system architecture, a single-channel pressure controller for the front axle and a two-channel pressure controller for the rear axle are therefore provided, that is to say both brake cylinders of the front axle are controlled by one pressure controller, and on the rear axle each brake cylinder on each side is respectively controlled by a dedicated pressure controller. In the prior art, one module with two channels is usually provided for the rear axle, and another module with one channel for the front axle. For the implementation of an electronic braking system, therefore three pressure control channels are often implemented.

To achieve better, side-specific ABS control, usually installed between the 1-channel pressure control module on the front axle and front-axle brake cylinders are ABS pressure control modules, 1 per wheel, which can hold or release the pressure on a wheel-by-wheel basis, and consequently 2 pneumatic channels are implemented on the front axle.

However, this means that wiring has to be provided, because communication must take place between the individual brake control valves (pressure controllers). This either involves the use of a large number of wires or additional electronics for digital communication between the components.

### SUMMARY OF THE INVENTION

It is therefore an object of the present invention to provide a compact brake control module from which the brake cylinders on the front axle and rear axle can be controlled.

This object may be achieved by a brake control module as claimed in claim 1 and a braking system as described herein. Further advantageous refinements of the present invention are the subject of the further descriptions herein.

A brake control module according to the invention has:
a first brake control valve, the output of which is connected to at least one controlled port (first and/or second controlled port);
a second brake control valve, the output of which is connected to a third controlled port;
a third brake control valve, the output of which is connected to a fourth controlled port;
a processor unit, which is adapted to control and/or influence brake pressures;
at least one control port, which is adapted to activate at least one of the brake control valves;
wherein the first brake control valve is connected to at least one first compressed air supply port,
and the second brake control valve and the third brake control valve are connected to at least one second compressed air supply port.

This creates a module with at least three valves in a structural unit with active electronics for the open-loop or closed-loop control of individual output pressures for each brake control valve. The fact that at least two separate compressed air supply ports are present means that two circuits can be separated from each other, so that, if there is a pressure loss of one circuit, the pressure of the other circuit is maintained, and thus the function of the other circuit can also be maintained. The first brake control valve has at least one controlled port; this is suitable for connecting the brake cylinders of the front axle. For the rear axle, a dedicated brake control valve is provided for each side, that is to say the second brake control valve and the third brake control valve. Thus, only one active processor unit (for example a microcontroller) is required; this is in the brake module, which is provided centrally (but a second, redundant microcontroller may also be provided as a fallback). In addition, this eliminates the wiring between the individual brake control valves (pressure controllers) that is provided in the prior art.

The output of the first brake control valve may have a first and a second controlled port. Thus, there is a port for each brake cylinder of the front axle, without the need here for external distributors or the like.

The first brake control valve may be connected to a first control port; the second brake control valve and the third brake control valve are connected to a second control port. This means that the front axle and the rear axle can be controlled separately—for example by pressure signals from a foot brake module.

Alternatively, there may be only one control port, but different control pressures are generated internally for each brake control valve.

All the components of the brake control module may be housed in one housing. This further minimizes the need for wiring and also ensures a compact configuration.

The first brake control valve, the second brake control valve and/or the third brake control valve may each be formed as a relay valve. Relay valves are particularly advantageous for use as brake control valves.

The first controlled port may be adapted to be connected to a first brake cylinder, which is provided to the left on the front axle of a vehicle, and/or the second controlled port is adapted to be connected to a second brake cylinder, which is provided to the right on the front axle of a vehicle, and/or the third controlled port is adapted to be connected to a third brake cylinder, which is provided to the left on the rear axle of a vehicle, and/or the fourth controlled port is adapted to be connected to the fourth brake cylinder, which is provided to the right on the rear axle of a vehicle. All the ports for the brake pressure are therefore available at the brake control module; this can be fitted anywhere in the vehicle, thus for example where there is space for such a module.

Further, the brake control module may have a fifth controlled port, which is connected to the output of the second brake control module, and the fifth controlled port is adapted to be connected to a further brake cylinder, which is provided to the left on a further rear axle of a vehicle. Furthermore, the brake control module may have a sixth controlled port, which is connected to the output of the third brake control valve, wherein the sixth controlled port is adapted to be connected to a further brake cylinder, which is provided to the right on a further rear axle of a vehicle. Thus, two rear axles can also be activated.

The first brake control valve may have an electrically actuated pilot valve assembly, and/or the second brake control valve may have a second electrically actuated pilot valve assembly, and/or the third brake control valve may have a third electrically actuated pilot valve assembly. Consequently, for each brake control valve there is or are one or more electrically actuated pilot valves—which serve as actuators for the electronics, thus enabling individual interventions through to no-exceptions electronic control of the brake pressures. These are used to improve vehicle stability, increase ride comfort and reduce braking system wear.

Further, a first pressure sensor, which is adapted to measure the pressure modulated by the first brake control valve, may be provided at the first brake control valve. Further, a second pressure sensor, which is adapted to measure the pressure modulated by the second brake control valve, may be provided at the second brake control valve Further, a third pressure sensor, which is adapted to measure the pressure modulated by the third brake control valve, may be provided at the third brake control valve. Furthermore, at least one acceleration and yaw rate sensor may be provided in the brake control module.

Using data from the pressure sensors, the microcontroller can be used to fine-tune the brake pressures. Data from the yaw rate and acceleration sensors is required to implement further braking functions.

A third compressed air supply port is also provided, and the first compressed air supply port and the third compressed air supply port may be connected to the first brake control valve via a pressure selection valve. This allows a third compressed air circuit to be provided and to intervene if the supply of compressed air from the first port fails (for example due to a leak), so that the first brake control valve never remains without supply pressure. The pressure selection valve may be a select-high valve, which connects to the first brake control valve the compressed air supply port at which there is a higher pressure. If a pressure loss occurs at the first compressed air supply port, an auxiliary circuit is consequently selected, and the front axle does not remain unbraked.

A braking system according to the invention has:
a brake control module as described above;
wherein at least one control port is connected to a foot brake module;
wherein the first controlled port is connected to a first brake cylinder via a first ABS valve;
wherein the second controlled port is connected to a second brake cylinder via a second ABS valve;
wherein the third controlled port is connected to a third brake cylinder;
wherein the fourth controlled port is connected to a fourth brake cylinder;
wherein the first brake cylinder and the second brake cylinder are assigned to a front axle of a vehicle, and
wherein the third brake cylinder and the fourth brake cylinder are assigned to a rear axle of a vehicle.

In the case of such an architecture, only one brake control module is necessary, which can appropriately control both the front axle and the rear axle(s).

Each control port may be connected to a separate foot brake valve of the foot brake module.

Exemplary embodiments of the present invention are described in more detail below with reference to the accompanying figures.

### BRIEF DESCRIPTIONS OF THE DRAWINGS

FIG. 1 shows a diagram of a brake control module 1.

FIG. 2 is a representation similar to FIG. 1; except that the supply of the compressed air at the first brake control valve 2 is different.

FIG. 3 shows a complete architecture of a corresponding braking system S.

### DETAILED DESCRIPTION

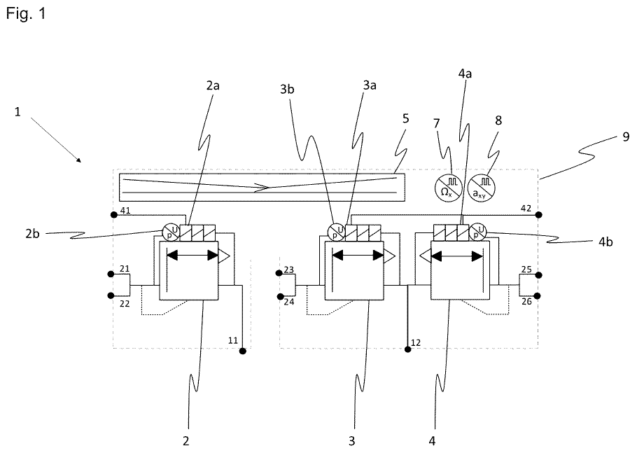

FIG. 1 shows a diagram of a brake control module 1, which contains a first brake control valve 2, a second brake control valve 3 and a third brake control valve 4. The first brake control valve 2 is connected to a first control port 41 and is supplied by a first compressed air supply port 11. The working ports of the first brake control valve 2 are a first controlled port 21 and a second controlled port 22. At the first brake control valve 21, a first pilot valve assembly 2a and a first pressure sensor 2b are provided; the first pressure sensor 2b measures the modulated working pressure.

Furthermore, a second brake control valve 3 is provided; this is supplied together with a third brake control valve 4 from a second compressed air supply port 12, and both are also connected to a second control port 42. Furthermore, the second brake control valve 3 is connected to a third controlled port 23 and a fifth controlled port 24; correspondingly, the third brake control valve 4 is connected to a fourth controlled port 25 and a sixth controlled port 26. At the second brake control valve 3, a second pilot valve assembly 3a and a second pressure sensor 3b are provided. Correspondingly, at the third brake control valve 4, a third pilot valve assembly 4a and a third pressure sensor 4b are provided. In FIG. 1, the first brake control valve 2, the second brake control valve 3 and the third brake control valve 4 are each formed as a relay valve. A processor unit 5 is also provided in the brake control module; furthermore, a yaw rate sensor 7 and an acceleration sensor 8 are provided here. The entire electronics for the brake control system are consequently also fitted in the brake control module. All the components are provided in a common housing 9.

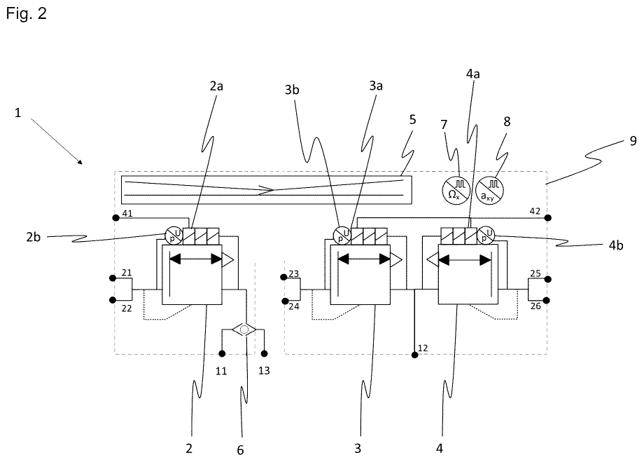

FIG. 2 is a representation similar to FIG. 1; it is just that here the supply of the compressed air at the first brake control valve 2 is different. Here, a first compressed air supply port 11 and a third compressed air supply port 13, which can be connected to separate pressure sources, are provided. Between the first compressed air supply port 11 and the third compressed air supply port 13, a pressure selection valve 6, in this case a so-called select-high valve, is provided. Depending on whether the pressure is higher in the first compressed air supply port 11 or in the third compressed air supply port 13, this corresponding port is connected to the first brake control valve 2. Therefore, if the pressure at the first compressed air supply port 11 fails, for example due to a leak, the third compressed air supply port 13 can consequently supply the first brake control valve 1 with pressure, so that it remains fundamentally possible to brake a front axle of a vehicle (the brake cylinders of which can be connected to the first controlled port 21 and the second controlled port 22). The third compressed air supply port 13 therefore represents an auxiliary brake circuit.

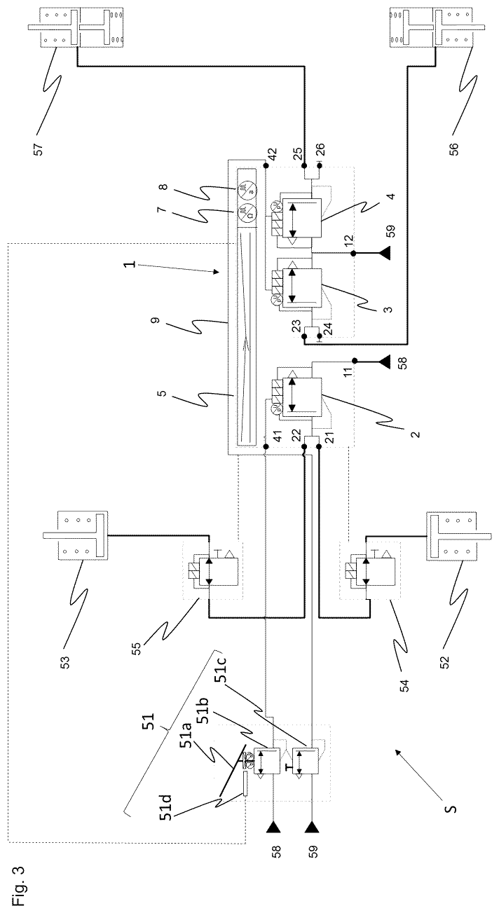

FIG. 3 shows a complete architecture of a corresponding braking system S. The brake control module 1 is described in the previous figures, but it is shown here that the first compressed air supply port 11 is connected to a first pressure source 58, and the second compressed air supply port 12 is connected to a second pressure source 59. These pressure sources are each also connected to a first foot brake valve 51b and a second foot brake valve 51c of a foot brake module 51. A pedal 51a controls the opening state of the first foot brake valve 51b and the second foot brake valve 51c. The output of the first foot brake valve 51b is connected to the first control port 41; the output of the second foot brake valve 51c is connected to the second control port 42.

In addition, a device 51d for the electronic detection of the braking request is connected to the processor unit 5.

In the case of the first controlled port 21, a connection to a first ABS valve 54 is provided; this in turn is connected to a first brake cylinder 52, which sits to the left on the front axle. Accordingly, the second controlled port 22 is connected to a second ABS valve 55; this in turn is connected to a second brake cylinder 53, which is mounted to the right on the front axle.

The two ABS valves 54, 55 are connected to the processor unit of the brake control module 1.

The third controlled port 23 is connected to a third brake cylinder 56, which is provided to the left on the rear axle, and the fourth controlled port 25 is connected to a fourth brake cylinder 57, which is provided to the right on the rear axle. The fifth controlled port 24 and the sixth controlled port 26 are not connected to brake cylinders in the present configuration. In such a braking system, two circuits are always considered necessary; the first pressure source 58 and the second pressure source 59 are not connected to each other, so that, if one of the pressure sources fails, the other pressure sources are still available.

The present invention is not limited to the embodiments shown. For example, a steering angle sensor and speed sensors could also be integrated into the system.

Furthermore, a further channel could also be integrated in the control module, for example a module for controlling the trailer. Further local wheel speed sensors could also be integrated into the system, but the device could also be integrated into a redundant braking system in which independent electronic control is possible.

### THE LIST OF REFERENCE SIGNS IS AS FOLLOWS

1 Brake control module
2 First brake control valve/relay valve
2a First pilot valve assembly
2b First pressure sensor
3 Second brake control valve/relay valve
3a Second pilot valve assembly
3b Second pressure sensor
4 Third brake control valve/relay valve
4a Third pilot valve assembly
4b Third pressure sensor
5 Processor unit
6 Pressure selection valve/select-high valve
7 Yaw rate sensor
8 Acceleration sensor
9 Housing
11 First compressed air supply port
12 Second compressed air supply port
13 Third compressed air supply port
21 First controlled port (front axle, left)
22 Second controlled port (front axle, left)
23 Third controlled port (first rear axle, left)
24 Fifth controlled port (second rear axle, left)
25 Fourth controlled port (first rear axle, right)
26 Sixth controlled port (second rear axle, right)
41 First control port (front axle)
42 Second control port (rear axle)
51 Foot brake module
51a Pedal
51b First foot brake valve
51c Second foot brake valve
51d Device for electronic detection of the braking request
52 First brake cylinder (front axle, left)
53 Second brake cylinder (front axle, right)
54 First ABS valve (front axle, left)
55 Second ABS valve (front axle, right)
56 Third brake cylinder (rear axle, left)
57 Fourth brake cylinder (rear axle, right)
58 First pressure source
59 Second pressure source
S Braking system

What is claimed is:

1. A brake control module, comprising:
a first brake control valve, an output of which is connected to at least one controlled port;
a second brake control valve, an output of which is connected to a third controlled port;
a third brake control valve, an output of which is connected to a fourth controlled port;
a processor unit, which is adapted to control and/or influence brake pressures;
at least one control port, which is adapted to activate at least one of the brake control valves;
wherein the first brake control valve is connected to at least one first compressed air supply port, and the second brake control valve and the third brake control valve are connected to at least one second compressed air supply port.

2. The brake control module of claim 1, wherein the output of the first brake control valve has a first controlled port and a second controlled port.

3. The brake control module of claim 1, wherein the first brake control valve is connected to a first control port, and the second brake control valve and the third brake control valve are connected to a second control port.

4. The brake control module of claim 1, wherein all the components of the brake control module are housed in one housing.

5. The brake control module of claim 1, wherein the first brake control valve, the second brake control valve and/or the third brake control valve each include a relay valve.

6. The brake control module of claim 2, wherein:
the first controlled port is adapted to be connected to a first brake cylinder, which is to the left on the front axle of a vehicle, and/or
the second controlled port is adapted to be connected to a second brake cylinder, which is to the right on the front axle of a vehicle, and/or
the third controlled port is adapted to be connected to a third brake cylinder, which is to the left on the rear axle of a vehicle, and/or
the fourth controlled port is adapted to be connected to a fourth brake cylinder, which is to the right on the rear axle of a vehicle.

7. The brake control module of claim 1, further comprising:
a fifth controlled port, which is connected to the output of the second brake control valve, wherein the fifth controlled port is adapted to be connected to a further brake cylinder, which is to the left on a further rear axle of a vehicle, and/or
a sixth controlled port, which is connected to the output of the third brake control valve, wherein the sixth controlled port is adapted to be connected to a further brake cylinder, which is to the right on a further rear axle of a vehicle.

8. The brake control module of claim 1, wherein the first brake control valve has a first electrically actuated pilot valve assembly, and/or the second brake control valve has a second electrically actuated pilot valve assembly, and/or the third brake control valve has a third electrically actuated pilot valve assembly.

9. The brake control module of claim 1, wherein a first pressure sensor, which is adapted to measure the pressure modulated by the first brake control valve, is at the first brake control valve, and/or
wherein a second pressure sensor, which is adapted to measure the pressure modulated by the second brake control valve, is at the second brake control valve, and/or
wherein a third pressure sensor, which is adapted to measure the pressure modulated by the third brake control valve, is at the third brake control valve, and/or
wherein at least one yaw rate sensor and/or acceleration sensor is in the brake control module.

10. The brake control module of claim 1, further comprising:
a third compressed air supply port, wherein the first compressed air supply port and the third compressed air supply port are connected to the first brake control valve via a pressure selection valve.

11. A braking system, comprising:
a brake control module, including:
a first brake control valve, an output of which is connected to at least one controlled port;
a second brake control valve, an output of which is connected to a third controlled port;
a third brake control valve, an output of which is connected to a fourth controlled port;
a processor unit, which is adapted to control and/or influence brake pressures;
at least one control port, which is adapted to activate at least one of the brake control valves;
wherein the first brake control valve is connected to at least one first compressed air supply port, and the second brake control valve and the third brake control valve are connected to at least one second compressed air supply port,
wherein at least one control port is connected to a foot brake module,
wherein the first controlled port is connected to a first brake cylinder via a first ABS valve,
wherein the second controlled port is connected to a first brake cylinder via a second ABS valve,
wherein the third controlled port is connected to a third brake cylinder,
wherein the fourth controlled port is connected to a fourth brake cylinder,
wherein the first brake cylinder and the second brake cylinder are assigned to a front axle of a vehicle, and
wherein the third brake cylinder and the fourth brake cylinder are assigned to a rear axle of a vehicle.

12. The brake control module of claim 1, further comprising:
a third compressed air supply port, wherein the first compressed air supply port and the third compressed air supply port are connected to the first brake control valve via a pressure selection valve, and wherein the pressure selection valve includes a select-high valve, which connects to the first brake control valve the compressed air supply port at which there is a higher pressure.
